(19) United States
(12) Patent Application Publication
(10) Pub. No.: US 2014/0168176 A1
(43) Pub. Date: Jun. 19, 2014

(54) MULTI-PURPOSE STYLUS FOR A COMPUTING DEVICE

(71) Applicant: MICROSOFT CORPORATION, Redmond, WA (US)

(72) Inventors: Andreas Georg Nowatzyk, San Jose, CA (US); David John Rasmussen, Redmond, WA (US)

(73) Assignee: Microsoft Corporation, Redmond, WA (US)

(21) Appl. No.: 13/717,281

(22) Filed: Dec. 17, 2012

(51) Int. Cl. G06F 3/0354

(52) U.S. Cl. CPC G06F 3/03545
USPC 345/179

(57) ABSTRACT

A multi-purpose stylus and method for communicating and interacting with a computing device both through physical contact and wirelessly. Embodiments of the stylus and method facilitate the use of the stylus as both a physical input instrument (by contacting a surface of the computing device to input data) and as a remote wireless instrument using a variety of auxiliary devices. Many types and combinations of auxiliary devices may be incorporated into embodiments of the stylus and method. These include one or more microphones and speakers, a laser pointer, a camera, a color sensor for obtaining color coordinates of an object, and an accelerometer to identify and interpret user gestures. Moreover, identification and authentication of a user may be achieved by including a fingerprint sensor and an identification device having a unique identifier. A transceiver is used to wireless communicate and control remote devices and the computing device.

### BACKGROUND

A stylus is often used with computer tablets, embedded devices, and mobile computers to allow a user to provide input to a computing device. Typically a user operates a touchscreen surface of the computing device with the stylus rather than using a finger. This increases the precision of the input by the user and allows a smaller user interface and more elements to be placed in that user interface. In addition, a stylus may be used to press or select items in the user interface and to handwrite, print, and draw on the touchscreen surface.

Although a stylus is quite useful it does have a number of inadequacies. A stylus (or a mouse) is typically used in two discrete modes: (1) performing the main task (such as inking, painting, and so forth); and (2) issuing commands. Unfortunately, most programs use valuable screen real estate to display commands alongside the main work area. This drastically reduces the space available for the main task. An alternative is to use a button or gesture to break out of the main work mode to issue a command. However, in programs with many commands, the user might need to navigate through myriad choices, often arranged in deep hierarchies.

A computer user often receives a reference to a video or audio file that they might wish to fully experience despite being in a location where audio would be considered rude or embarrassing. The current solution to this problem is to either leave the area, or to find a personal listening device such as a headset or earphones, headphones. This is so inconvenient that users will often flag the file to be enjoyed at a later time, which can seriously disturb their workflow.

When a user wishes to take a video (or audio) call in a public place, using the microphone that is built into their computing device may prove challenging. If they wish to see the screen they usually hold the device a certain distance away. However, at that distance the microphone in the device may be unable to distinguish background noise from the user's speech. A similar challenge occurs for hearing the audio that is emanating from the device.

Computing devices are beginning to incorporate modes to allow a user to receive push notifications even during when the device is in a low-power state. For example, a tablet or slate computer may know that an urgent email has arrived. However, if the computing device is in a bag or briefcase it might be difficult to notify the user of the pending message in a socially appropriate fashion.

When using a painting or drawing program there is often a desire to match a color in the real world. This is currently done by adjusting on-screen controls until the color matches. However, this can be a tedious and an unreliable process.

When video conferencing with a remote colleague, one will often wish to show something in the environment to the remote viewer. This is currently achieved by moving the entire device to give the appropriate view. Not only is this awkward, but it breaks the flow of the conversation because the main video chat must be suspended while the camera is moved to show the desired scene. Moreover, the physical size of the device often makes it impossible to obtain the desired view.

When travelling with a computing device one often has the desire to take a note, or take a picture but is thwarted by the need to get the device out of a bag or briefcase and then re-stow it after use. This cumbersome process means that important notes and pictures are often not taken.

When giving a presentation presenters often like the freedom to walk around without carrying a large device. To fill this need, remote presentation controllers are available. However, this is just one more device to be carried and charged. Moreover, current styli for computing devices are only active in close proximity to the writing surface. To use simple gestures for commands a user is forced to use the touchscreen surface.

When recording an audio message the microphone on a computing device is often located too far away from the audio source. This means that it often ends up picking up environmental (or surrounding) noise. Although microphone arrays can help with this problem they could work significantly better if there was an additional microphone placed close to the speaker. Then the close microphone signal could be de-noised using the ambient noise signal from the far microphone. Unfortunately, there is no way convenient way to do this if the microphones are restricted to being integrated near the display, as is the case for many computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the multi-purpose stylus and method facilitate the use of the stylus as both a physical input instrument and a remote wireless instrument using a variety of auxiliary devices. In particular, embodiments of the stylus and method allow a user to input data to a computing device by physically contacting a touchscreen surface of the computing device while also using the stylus as a platform for auxiliary devices incorporated into the stylus. Currently, styli are designed to interact only with the display. However, the size, shape, and detachability of a stylus make it a useful platform for hosting other functionality and auxiliary devices. This allows embodiments of the stylus and method to interact with multiple devices.

Embodiments of the stylus and method include a number of auxiliary devices that may be incorporated onto the stylus. This includes one or more microphones that may be located anywhere along the length of the stylus body. Moreover, in some embodiments only a single microphone is used, while in other embodiments a plurality of microphones is used. Embodiments of the stylus and method also include one or more speakers that may be located anywhere along the stylus body. The microphone and speakers facilitate a variety of functionality, including using the stylus as a telephone, recording and storing audio notes on the stylus, denoising an audio signal, and playback of audio without the need to using the computing device.

Embodiments of the multi-purpose stylus may also include a laser pointer and a camera. This facilitates the use of the laser pointer to point out a specific detail and the camera to take a picture or video. This allows real-time demonstration and explanations using embodiments of the stylus. Embodiments of the stylus and method also may include color sensor that provides color coordinates of a color sample. This allows a user to obtain a color match and to compare colors on materials.

A fingerprint sensor may be included as an auxiliary device in embodiments of the stylus and method. The fingerprint sensor allows the use of a user's fingerprints to authenticate and identify the user. Moreover, an identification device incorporated in the stylus and containing a unique identifier may be used to authenticate and identify the user. An accelerometer or other motion-sensing device can be incorporated into the stylus and method to facilitate identification and interpretation of user gestures. This includes using gestures to enter a password and authenticate the user.

Embodiments of the stylus and method may include a transceiver for communicating wirelessly with other devices (including the computing device). Moreover, a tactile feedback device may be incorporated into embodiments of the stylus and method to provide tactile feedback (such as vibration) to the user to alert the user to notifications through the stylus. Embodiments of the multi-purpose stylus and method may also include memory storage device. This memory storage device may be internal or external to the stylus and allow the stylus to store data, such as audio data obtained through the microphone. In addition, embodiments of the stylus and method include a docking cradle with charging contacts to facilitate charging of the stylus when it is placed in the docking cradle.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the multi-purpose stylus and method implemented in a computing environment.

FIG. 2 illustrates a simplified example of a general-purpose computer system on which various embodiments and elements of the multi-purpose stylus and method, as described herein and shown in FIGS. 1 and 3-6, may be implemented.

FIG. 3 is a flow diagram illustrating the general operation of embodiments of the multi-purpose stylus and method shown in FIG. 1.

FIG. 4 is a diagram illustrating the structural details of an exemplary implementation of embodiments of the multi-purpose stylus shown in FIG. 1.

FIG. 5 is a flow diagram illustrating the operational details of the embodiments of the multi-purpose stylus shown in FIGS. 1, 3, and 4.

FIG. 6 is a block diagram illustrating the details of various possible embodiments of the multi-purpose stylus and method shown in FIGS. 1 and 3-5.

### DETAILED DESCRIPTION

In the following description of embodiments of a multi-purpose stylus and method reference is made to the accompanying drawings, which form a part thereof, and in which is shown by way of illustration a specific example whereby embodiments of the multi-purpose stylus and method may be practiced. It is to be understood that other embodiments may be utilized and structural changes may be made without departing from the scope of the claimed subject matter.

### I. System Overview

Embodiments of the multi-purpose stylus and method incorporate a number of functionality into the stylus platform while still allowing the use of the stylus as a way to input data to a computing device by physically contacting a surface of the computing device. In addition, embodiments of the multi-purpose stylus and method can interact with multiple devices and collect and supply data using a variety of device located on the stylus. This provides a variety of functionality on a single platform.

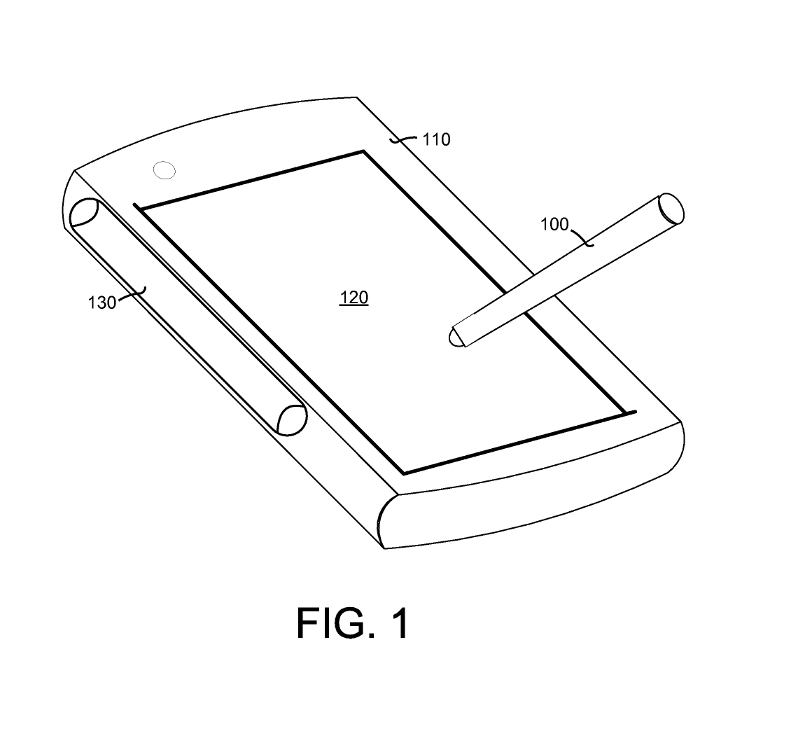

FIG. 1 is a block diagram illustrating a general overview of embodiments of the multi-purpose stylus and method implemented in a computing environment. In particular, embodiments of the multi-purpose stylus 100 include a computing device 110 having a surface 120, such as a touchscreen surface. It should be noted that the computing device 110 might be virtually any device having a processor and a touchscreen surface that allows input by a stylus.

Embodiments of the multi-purpose stylus 100 also include a docking cradle 130 that serve at least two purposes. First, the docking cradle 130 provides a way in which embodiments of the multi-purpose stylus 100 can be attached to the computing device 110. This allows embodiments of the multi-purpose stylus 100 and the computing device 110 to be transported as a single unit rather than separate pieces. Second, the docking cradle 130 includes a recharging means (not shown) that allows embodiments of the multi-purpose stylus 100 to begin recharging immediately upon being placed in the docking cradle 130.

Embodiments of the multi-purpose stylus 100 are used to input information (such as data and commands) into the computing device 110. This input of data occurs by having a user (not shown) hold embodiments of the multi-purpose stylus 100 and place the tip of the multi-purpose stylus 100 in physical contact with the surface 120 and perform any of a variety of movements. These movements include pressing on the surface 120, printing and writing on the surface 120, and drawing on the surface 120. With this and various other movements the user can physically interact with the computing device 110 using embodiments of the multi-purpose stylus 100 and the surface 120. Moreover, as explained in detail below, the additional functionality of embodiments of the multi-purpose stylus 100 allow the user to also interact with the computing device 110 and other devices and even use the multi-purpose stylus 100 as a stand-alone computing device.

### II. Exemplary Operating Environment

Before proceeding further with the operational overview and details of embodiments of the multi-purpose stylus 100 and method, a discussion will now be presented of an exemplary operating environment in which embodiments of the multi-purpose stylus 100 and method may operate. Embodiments of the multi-purpose stylus 100 and method described herein are operational within numerous types of general purpose or special purpose computing system environments or configurations.

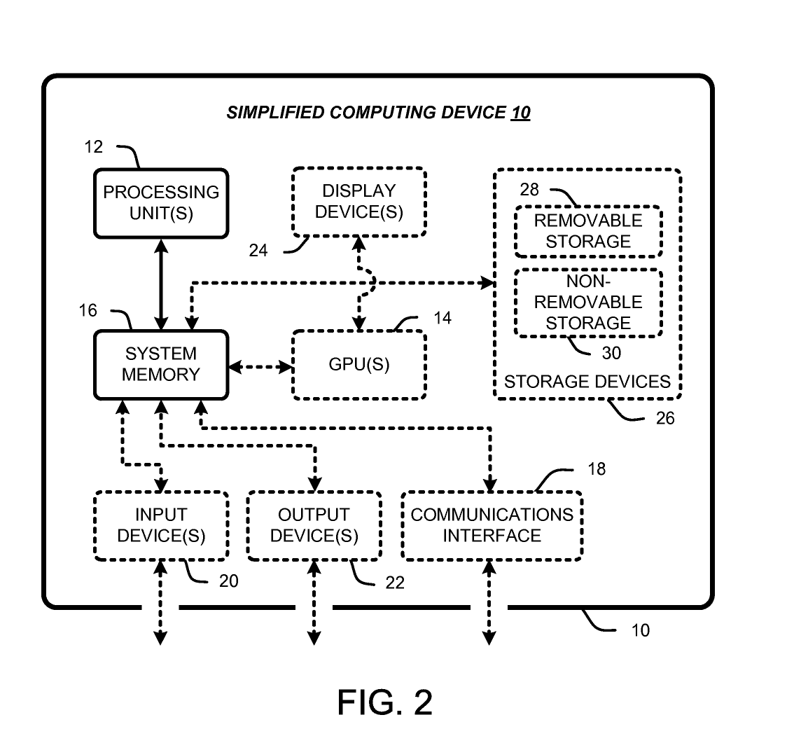

FIG. 2 illustrates a simplified example of a general-purpose computer system on which various embodiments and elements of the multi-purpose stylus 100 and method, as described herein and shown in FIGS. 1 and 3-6, may be implemented. It should be noted that any boxes that are represented by broken or dashed lines in FIG. 2 represent alternate embodiments of the simplified computing device, and that any or all of these alternate embodiments, as described below, may be used in combination with other alternate embodiments that are described throughout this document.

For example, FIG. 2 shows a general system diagram showing a simplified computing device 10. The simplified computing device 10 may be a simplified version of the computing device 110 shown in FIG. 1 and even embodiments of the multi-purpose stylus 100. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement embodiments of the multi-purpose stylus 100 and method described herein, the device should have a sufficient computational capability and system memory to enable basic computational operations. In particular, as illustrated by FIG. 2, the computational capability is generally illustrated by one or more processing unit(s) 12, and may also include one or more GPUs 14, either or both in communication with system memory 16. Note that that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device 10 of FIG. 2 may also include other components, such as, for example, a communications interface 18. The simplified computing device 10 of FIG. 2 may also include one or more conventional computer input devices 20 (e.g., styli), pointing devices, keyboards, audio input devices, video input devices, haptic input devices, devices for receiving wired or wireless data transmissions, etc.). The simplified computing device 10 of FIG. 2 may also include other optional components, such as, for example, one or more conventional computer output devices 22 (e.g., display device(s) 24, audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device 10 of FIG. 2 may also include a variety of computer readable media. Computer readable media can be any available media that can be accessed by the simplified computing device 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the multi-purpose stylus 100 and method described herein, or portions thereof, may be stored, received, transmitted, or read from any desired combination of computer or machine readable media or storage devices and communication media in the form of computer executable instructions or other data structures.

Finally, embodiments of the multi-purpose stylus 100 and method described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### III. Operational Overview

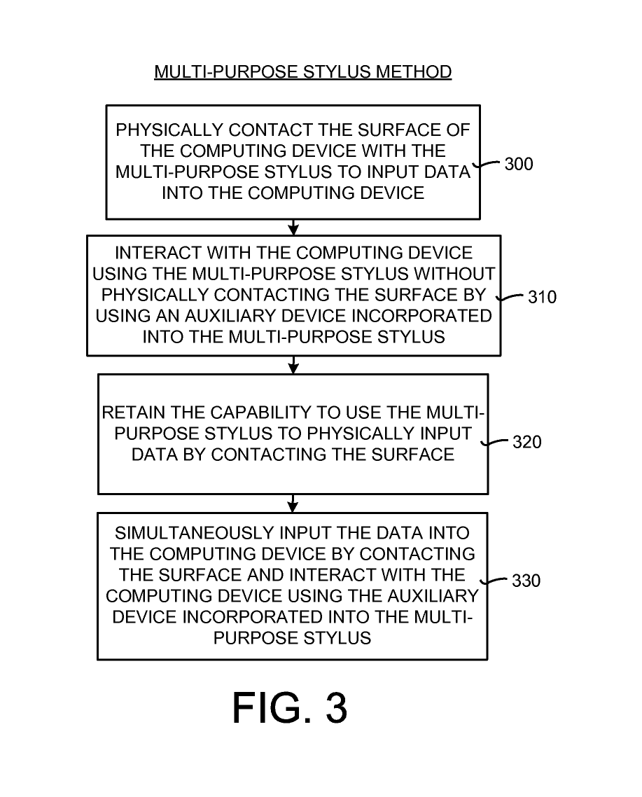

FIG. 3 is a flow diagram illustrating the general operation of embodiments of the multi-purpose stylus 100 and method shown in FIG. 1. As shown in FIG. 3, the operation of embodiments of the multi-purpose stylus method begins physically contacting the surface 120 of the computing device 110 with embodiments of the multi-purpose stylus 100 (box 300). This allows a user (not shown) to input data into the computing device 110. Typically the user will hold the multi-purpose stylus 100 in his or her hand while contacting the surface 120 in order to input the data to the computing device 110.

The method also includes interacting with the computing device 110 using embodiments of the multi-purpose stylus 100 without any physical contact of the surface 120 by embodiments of the multi-purpose stylus 100 (box 310). This is achieved by incorporating one or more auxiliary devices into embodiments of the multi-purpose stylus 100. As described in detail below, these auxiliary devices may be any one or more of a plurality of devices, such as microphones, speakers, tactile feedback devices, color sensors, and so forth.

This allows the user not only to input data into the computing device 110 by using embodiments of the multi-purpose stylus 100 to write on the surface 120, but also to interact with the computing device 110 through non-physical contact means. In other words, to interact with the computing device through embodiments of the multi-purpose stylus 100 without using the stylus 100 on the surface 120. The user maintains the capability to use embodiments of the multi-purpose stylus 100 to physically input data to the computing device 110 by contacting the surface 120 (box 320).

In addition, embodiments of the multi-purpose stylus 100 method facilitate the simultaneous input of data into the computing device 110 through the stylus 100 using both physical contact and non-physical means (box 330). In particular, the user can input data into the computing device 110 by physically contacting the surface 120 while simultaneously input data into the computing device 110 in a touchless manner using the auxiliary devices that are incorporated into embodiments of the multi-purpose stylus 100.

### IV. System and Operational Details

The system and operational details of embodiments of the multi-purpose stylus 100 and method will now be discussed. This includes a discussion of which auxiliary devices may be incorporated into embodiments of the multi-purpose stylus 100 and the operation of those various devices. In addition, the interoperability of these auxiliary devices in relation to each other will be discussed. It should be noted that the discussion is focused on exemplary embodiments for pedagogical purposes and is not an exhaustive list of each and every way in which the various auxiliary devices discussed may be mixed and match.

### IV.A. Structure of the Multi-Purpose Stylus and Auxiliary Devices

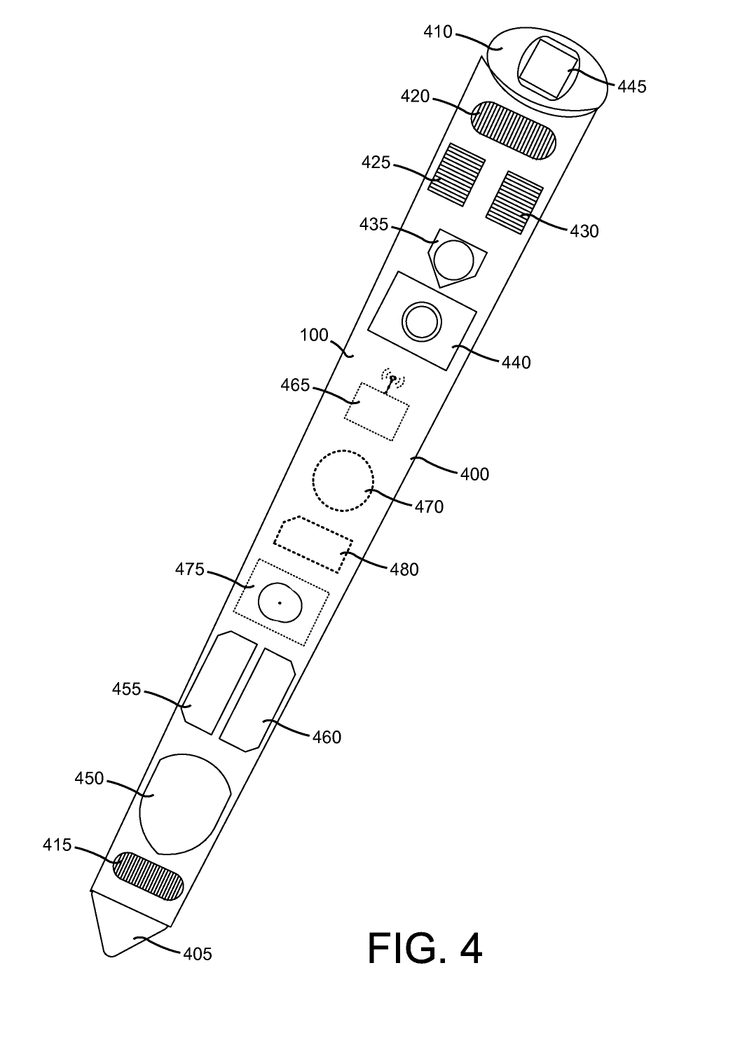

FIG. 4 is a diagram illustrating the structural details of an exemplary implementation of embodiments of the multi-purpose stylus 100 shown in FIG. 1. It should be noted that in the following discussion various structural elements are shown incorporated into embodiments of the multi-purpose stylus 100. However, this illustration is exemplary only and meant to show some of the possible auxiliary devices that may be used with embodiments of the multi-purpose stylus 100. Many other combinations and placements of these auxiliary devices are possible. Moreover, the shape of the stylus 100 is only exemplary and may be different from that shown in FIG. 4.

As shown in FIG. 4, embodiments of the multi-purpose stylus 100 include stylus body 400. At one end of the stylus body 400 is a stylus tip 405 and at the other end is the distal end 410 of the stylus body 400. Various combinations of auxiliary devices may be incorporated into embodiments of the multi-purpose stylus 100. This includes one or more microphones, such as a first microphone 415 located near the stylus tip 405 and a second microphone 420 located near the distal end 410. One or more microphones may be located anywhere along the length of the stylus body 400. Moreover, in some embodiments only a single microphone is used, while in other embodiments a plurality of microphones is used.

Some embodiments of the multi-purpose stylus 100 include one or more speakers that may be located anywhere along the stylus body 400. As shown in FIG. 4, a first speaker 425 and a second speaker 430 are illustrated near the distal end 410 of the stylus body 400. However, in other embodiments there may be only one speaker while in still other embodiments there may be more than two speakers.

Embodiments of the multi-purpose stylus 100 may also include a laser pointer 435 and a camera 440. As explained in detail below, the laser pointer 435 typically will be located near the camera 440. However, the laser pointer 435 and the camera 440 can be located anywhere along the stylus body 400. Moreover, embodiments of the multi-purpose stylus 100 may include both the laser pointer 435 and the camera 440 or either one of these auxiliary devices alone. The camera may be a still camera only, a video camera only, or a combination of both.

Embodiments of the multi-purpose stylus 100 may also include a color sensor 445 that provides color coordinates of a color sample. A fingerprint sensor 450 may also be included. The fingerprint sensor facilitates various authentication scenarios so that a user of the multi-purpose stylus 100 can be authenticated through fingerprints. Charging contacts, including a first charging contact 455 and a second charging contact 460, are incorporated onto the stylus body 400 to facilitate charging of the stylus 100 when it is placed in the docking cradle 130. It should be noted that although two charging contacts are illustrated, more or fewer charging contacts might be used in various embodiments of the multi-purpose stylus 100.

Various auxiliary devices may be internal to embodiments of the multi-purpose stylus 100. These are shown in FIG. 4 as having dotted lines to indicate that they are at least partially internal to the stylus body 400. A transceiver 465 for communicating wirelessly with other devices (including the computing device 110) may be incorporated within some embodiments of the multi-purpose stylus 100. Moreover, some embodiments of the multi-purpose stylus 100 may include an accelerometer 470 for detecting and interpreting various gestures that the user may make while holding the stylus 100. It should be noted that the accelerometer 470 might be any device capable of detecting motion of the stylus 100.

Embodiments of the multi-purpose stylus 100 also may include a tactile feedback device 475. This includes devices capable of providing vibration feedback to the user to alert or notify the user of specified events. The tactile feedback device 475 may be virtually any device capable of providing tactile feedback to the user such that the user can feel through embodiments of the multi-purpose stylus 100 when a notification is received.

Embodiments of the multi-purpose stylus 100 may also include memory storage device. This memory storage device may be internal to the stylus 100, may be external so as to allow an external memory storage device to plug into the stylus 100, or both. In some embodiments this memory storage device includes an identifier device 480 that contains a unique identifier encoded thereon. This unique identifier may identify and correspond to the user of the stylus 100.

### IV.B. Operational Details of the Multi-Purpose Stylus and Method

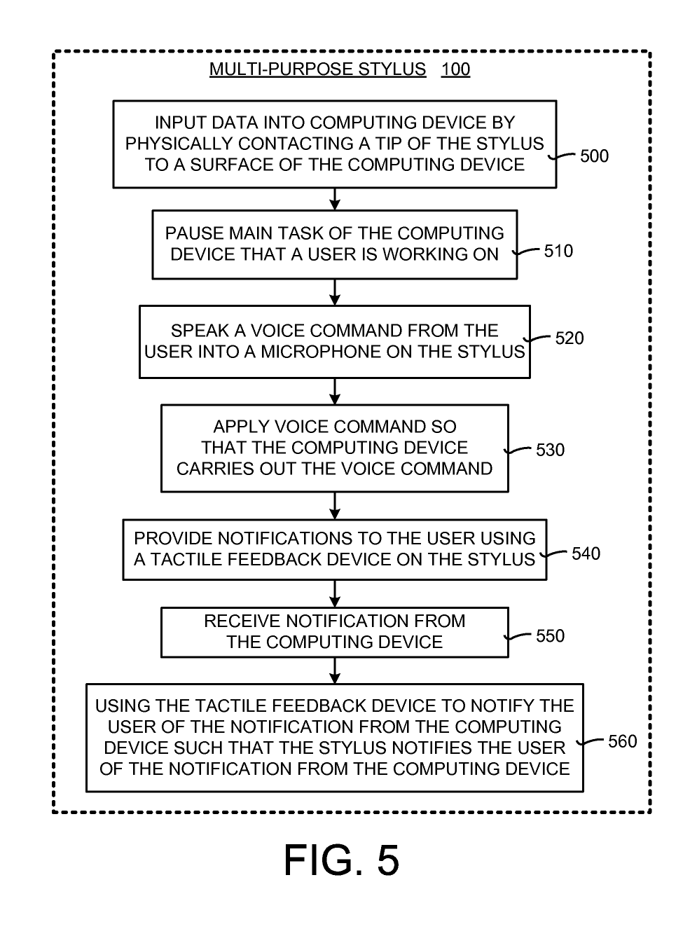

FIG. 5 is a flow diagram illustrating the operational details of the embodiments of the multi-purpose stylus 100 shown in FIGS. 1, 3, and 4. As shown in FIG. 5, the operation begins by inputting data into the computing device 110 by physically contacting the stylus tip 405 to the surface 120 of the computing device 110 (box 500). In some embodiments the user pauses a main task of the computing device 110 that the user is working on (box 510). For example, the main task may be that the user is interacting with an application on the computing device 110.

The user then speaks a voice command into one or more of the microphone 415, 420 on the stylus 100 (box 520). The voice command then is applied so that the computing device 110 carries out the voice command (box 530). In addition, the tactile feedback device 475 is used to provide notifications to the user (box 540). When a notification is received from the computing device 110 (box 550), then the tactile feedback device 475 is used to notify the user of the notification (box 560). In other words, through the tactile feedback device 475 the stylus 100 is used to notify a user of notification from the computing device 110.

### IV.C. Embodiments and Scenarios of the Multi-Purpose Stylus

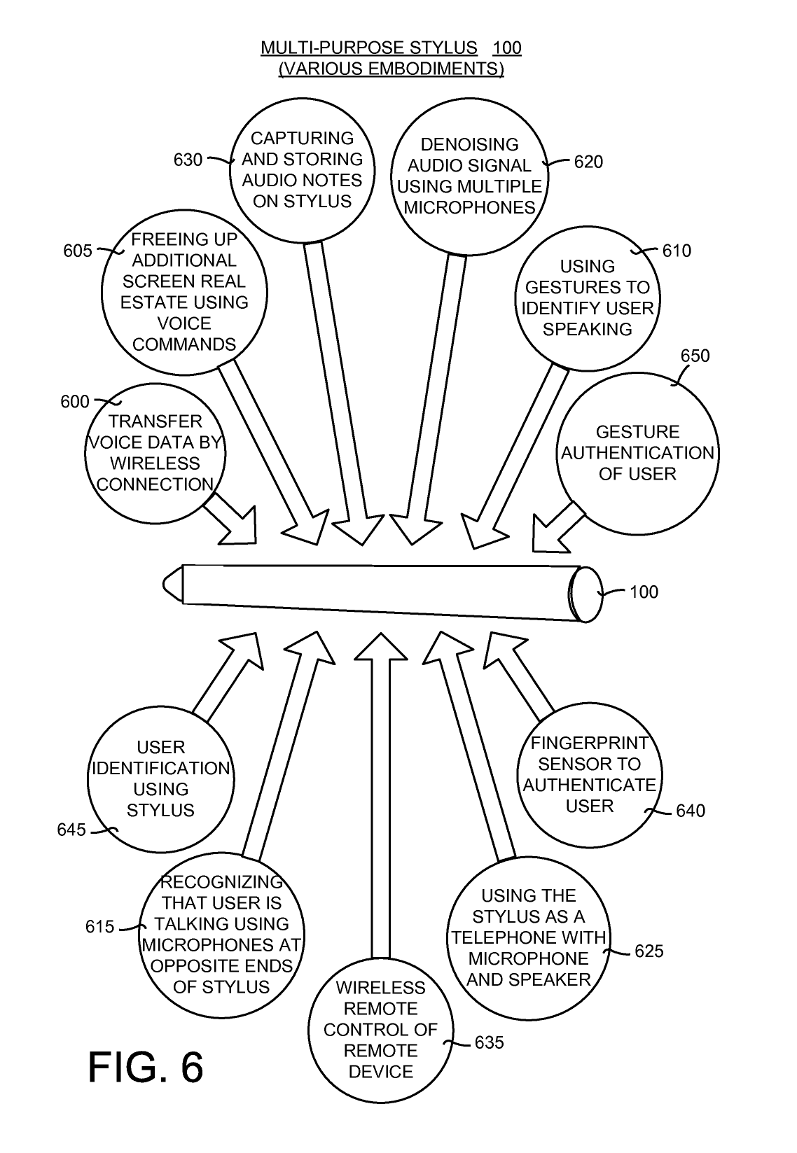

The auxiliary devices described above may be used in a variety of combinations and scenarios. FIG. 6 is a block diagram illustrating the details of various possible embodiments of the multi-purpose stylus 100 and method shown in FIGS. 1 and 3-5.

### IV.C.1. Microphone

Some embodiments of the multi-purpose stylus 100 and method contain one or more microphones. Microphones allow a user to record commands, annotations, or both. In addition to the microphones, some embodiments of the multi-purpose stylus 100 and method include a radio link (using the transceiver 465) to the computing device 110. This allows wireless operation. As shown in FIG. 6, data (such as voice data) can be transferred wirelessly to the computing device 110 or remote devices through the wireless connection facilitated by the transceiver 465 (bubble 600).

Moreover, in some embodiments a rechargeable battery powers the stylus 100. In these embodiments the stylus 100 is recharged in the docking cradle 130 such that the moment that the stylus 130 is docked to the computing device 110 it is being recharged.

In some embodiments the onboard microphones 415, 420 are coupled with a technique for indicating an active speech input. This allows embodiments of the multi-purpose stylus 100 to be used for used for dictation, giving commands, or other general-purpose recording tasks. This allows more screen real estate to be used for the main task because any commands can be given verbally. As shown in FIG. 6, using voice commands allows the freeing up of additional screen real estate since the commands do not need to be displayed in the user interface (bubble 605).

Moreover, speech is a particularly good way of selecting among a very large number of commands. By placing the microphone in the stylus 100, the user can easily pause the main task, speak a command into the stylus 100, and then apply the command. Because the microphone in the stylus 100 can be placed close to the user's mouth, the speech signal can be much higher quality than that which could be obtained from a distant microphone in a noisy environment. The proximity will also allow the user to whisper commands making the use of speech input much less annoying to others nearby.

In some embodiments the multi-purpose stylus 100 and method incorporates a push-to-talk input that tells the system to start listening for commands. Alternatively, as shown in FIG. 6, embodiments of the stylus 100 and method can recognize the gesture of bringing the microphone close to the mouth to identify that the user is speaking (bubble 610). In other embodiments, the proximity of the sound source being very near the microphone causes the stylus 100 to automatically recognize that a command is being issued. The latter can be accomplished using a plurality of microphones spaced along the stylus 100. As shown in FIG. 6, this means that embodiments of the stylus 100 and method recognize that the user is speaking by using microphones at opposite ends of the stylus 100 (bubble 615). A much stronger signal at microphone located at one end of the stylus 100 versus at a microphone located at an opposite end of the stylus 100 indicates a close speaker.

In a multi-user environment where each user has a stylus 100 for working on a shared display, the microphone contained onboard the stylus 100 gives a convenient interface for changing the functionality of an individual stylus 100. For example, an urban planner might command his or her stylus to configure roads, while another may choose sewer lines.

Moreover, the one or more microphones in embodiments of the multi-purpose stylus 100 and method can be used in combination with microphones located elsewhere (such as on the computing device 110). As shown in FIG. 6, denoising of an audio signal can be performed using multiple microphones (bubble 620). This allows an audio signal from a close microphone signal (such as the microphone on the stylus 100) to be denoised using the ambient noise signal from a far microphone (such as a microphone on the computing device 110).

It should be noted that a number of applications might benefit from having microphones located at different ends of the stylus 100. For quick commands, a microphone located at a distal end 410 is most convenient. As shown in FIG. 6, some embodiments of the stylus 100 and method include a speaker with the microphone and allow the stylus 100 to be used as a telephone (bubble 625). In this case, the may be placed proximate to the stylus tip 405 and the speaker may be placed at the opposite end of the stylus body 400.

As shown in FIG. 6, embodiments of the stylus 100 and method may also be used to capture and store audio notes (bubble 630). Embodiments that include microphones incorporated into the stylus 100 allow the stylus 100 to be used for quick audio notes when the computing device 110 is unavailable. This allows the user to capture important notes that might otherwise go undocumented. It also alleviates having to stow a cumbersome computing device. The stylus 100 can easily be placed in a user's pocket thereby making it more accessible than the larger computing device 110.

### IV.C.2. Speakers and Audio Playback

A user will sometimes receive a link or an attachment to a video or audio file that they want to view or hear but might wish to fully experience despite being in a location where audio would be considered rude or embarrassing. The current solution to this problem is to either leave the area, or to find a personal listening device such as a headset, earphones, or headphones.

Some embodiments of the multi-purpose stylus 100 and method include at least one small, low-power speaker that allows audio to be discretely presented to a user by placing the end of the stylus 100 near the user's ear. This allows the use to enjoy and audio file without leaving the area or disturbing others. For this reason it typically desirable if the audio or video does not begin playing until the stylus 100 is placed at the user's ear.

Some embodiments of the stylus 100 and method include an ear proximity sensor that automatically detects when the ear is near the stylus 100. In alternate embodiments the gesture of moving the stylus 100 to the ear could be detected using inertial or other types of sensors. In other embodiments a detector switch is included at the end of the stylus 100. The ability to sense the user's attention (such as having the stylus 100 in or near the ear) can be used for other automated functionality, such as launching appropriate application modes, or pausing the audio in real-time conversations when the device is removed from the ear, but catching up without missing anything when it is returned to the ear, and a simple repeat and backup functionality.

In some embodiments of the stylus 100 and method the speakers are combined with microphones. In these embodiments the embodiments of the stylus 100 and method can both present and receive audio. As noted above, this allows embodiments of the stylus 100 to be used similar to a telephone.

### IV.C.3. Tactile Feedback Device

Some embodiments of the stylus 100 and method using the tactile feedback device 475 (such as a vibration mechanism) to allow the user to be discretely notified. This is true even when the computing device 110 is not directly on the person (such as when it is in a bag or briefcase). This tactile feedback device 475 can be used to signal any type of notification, such as an incoming message or an upcoming appointment, etc.

### IV.C.4. Color Sensor

Some embodiments of the stylus 100 and method include the color sensor 445. The color sensor allows the stylus 100 to be used to sample colors in the real world for use in drawing, painting and other applications. There are a number of extensions to this idea. By way of example, the color sensor 445 could include one or more light sources for judging color under different lighting conditions. This could allow a measure of true color, which would be independent of ambient lighting conditions. Similarly, instead of a simple color sensor, a camera could be used to record textures and other visual features for similar applications.

It is worth noting that there are a number of ways in which the stylus 100 might be commanded to sample a color. For example, the stylus 100 might be given an audio command to “sample color” with the actual sample taken when a switch near the color sensor 445 is actuated. This would allow the user to hold pen to a surface and obtain the color coordinates of that surface. The color sensor 445 can also be used to match a particular color and determine how close two colors are to each other.

### IV.C.5. Camera and Laser Pointer

A camera 440 can be added to some embodiments of the stylus 100 and method to allow alternative viewpoints during video conferencing, and to allow very quick capture even when the computing device 110 is not present. In some embodiments the camera 440 is a still camera that takes still photographs. Moreover, in other embodiments the laser pointer 435 is used along with the camera 440. For example, a mechanic might use these embodiments of the stylus 100 while conferring with a remote engineer, using the laser pointer 435 to highlight and the camera 440 to shown different engine components while continuing the conversation.

In more complex embodiments the camera 440 is a video camera. This allows embodiments of the stylus 100 to stream live video to the main computing device 110. In some cases this video stream can be recorded for later use. In these types of applications it is also be useful to include audio recording.

### IV.C.6. Remote Control of Remote Devices

Some embodiments of the stylus 100 and method use the transceiver 465 to allow the stylus 100 to act as a remote control for a remote device while giving a presentation. This allows remote control of the remote device using embodiments of the stylus 100 and method (bubble 635). For example, these embodiments of the stylus 100 can be used to indicate when to advance to the next slide. This could be done using a button, a gesture, a verbal command, and so forth.

A more sophisticated remote control scenario might include pointing functionality (such as the laser pointer 435), or gyroscopic mouse functionality. This might be accomplished with inertial sensors (such as gyroscopes, accelerometers, and so forth). In these embodiments the stylus 100 can interact with the environment. For example, using the transceiver 465 embodiments of the stylus 100 can determine that there is a display in a room, automatically connect with the display, and use it in the presentation while controlling the display from the stylus 100.

### IV.C.7. Accelerometer and Motion-Sensing Devices

Inertial, audio or other sensors (such as the accelerometer 470) can be used to allow embodiments of the stylus 100 to detect certain gestures, even when these are not made on the surface 120. This could include gestures made in the air (while the user holds the stylus 100) or on another surface. For example, making an “L” gesture in the air or on a table might indicate that you wish to tell participants at your next meeting that you are running late.

### IV.C.8. Sensors, Authentication, and Other Scenarios

Embodiments of the stylus 100 and method can include a variety of additional sensors incorporated into the stylus 100. These include the fingerprint sensor 450 for scanning the user's fingerprint. As shown in FIG. 6, the fingerprint sensor 450 allows embodiments of the stylus 100 and method to authenticate a user through his or her fingerprints (bubble 640). Moreover, the identifier device 480 allows the user to be identified and authenticated using embodiments of the stylus 100 and method (bubble 645). Some embodiments of the stylus 100 and method allow authentication of the user through gestures (bubble 650). Using the accelerometer 470 a gesture could be used as a “pass gesture” to authenticate the user or enter a password. Moreover, commands can be issued using the stylus 100 through gestures.

It should be noted that very complex scenarios are possible when these features are combined. For example, imagine that a user receives a call from an important client while her main device is stowed. The stylus 100 vibrates to indicate the incoming call, and the user places the stylus 100 in her ear to find out who is calling. Learning that it is her client, she gestures an “A” in the air to indicate that she wishes to take the call. She then holds the stylus 100 to her ear and mouth like a telephone. She begins her conversation and starts searching for her bag with her slate. It is across the room. She takes the stylus 100 away from her face, which pauses the conversation and mutes the microphone, and calls to her assistant to bring the bag over. When she returns the stylus to her ear the conversation begins again. The client has been speaking, but she has not missed anything because the time while she was away is played first, slightly sped up to get her back to real-time quickly. She takes her slate out of her bag and wakes it up. She tells your client she can now switch to a video chat, and she turns on the camera and microphone in the slate by taping in the appropriate icon. As she continues her conversation, the client asks to see her product, which in this example is a new athletic shoe. She grabs the sample from her bag, and holds it up, describing the features. The client asks about her innovative toe cushion, so she uses the camera of the stylus 100 to grab a shot inside the shoe. It appears in a side window in your display. This is but one scenario in which features and auxiliary devices that can be incorporated onto the stylus 100 can be used together.

Moreover, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for communicating with a computing device using a multi-purpose stylus, comprising:
physically contacting a surface of the computing device using the multi-purpose stylus to input data into the computing device; and
interacting with the computing device in a non-physical manner using the multi-purpose stylus such that the multi-purpose stylus does not physically touch the surface by using a secondary device incorporated in the multi-purpose stylus while retaining a capability to use the multi-purpose stylus to physically input the data.

2. The method of claim 1, further comprising incorporating a microphone into the multi-purpose stylus.

3. The method of claim 2, further comprising transferring voice data captured by the microphone to the computing device using a wireless link incorporated into the multi-purpose stylus.

4. The method of claim 2, further comprising:
issuing voice commands to the computing device using the microphone such that the voice commands are given verbally; and
displaying a main work area and none of the voice commands on a display of the computing device such that using the voice commands frees up additional screen real estate because the voice commands are issued verbally.

5. The method of claim 2, further comprising:
capturing audio notes using the microphone; and
storing the audio notes on the multi-purpose stylus.

6. The method of claim 2, further comprising performing denoising of an audio signal received from the microphone using an ambient noise signal obtained from a microphone located on the computing device.

7. The method of claim 4, further comprising:
incorporating an accelerometer into the multi-purpose stylus; and
recognizing a gesture of bringing the microphone near to a sound source using the accelerometer to identify that voice commands is being issued.

8. The method of claim 4, further comprising incorporating a plurality of microphones along a length of the multi-purpose stylus.

9. The method of claim 4, further comprising:
receiving a first audio signal from a first microphone of the plurality of microphones located along the length of the multi-purpose stylus;
receiving a second audio signal from a second microphone of the plurality of microphones located along the length the multi-purpose stylus that is nearer a sound source than the first microphone; and
determining that voice commands are being issued when the second audio signal is stronger than the first audio signal.

10. The method of claim 1, further comprising:
incorporating an accelerometer into the multi-purpose stylus; and
using the accelerometer to recognize physical gesturing performed by a user holding the multi-purpose stylus to authenticate the user.

11. The method of claim 1, further comprising:
embedding an identifier device into the multi-purpose stylus; and
encoding a unique identifier into the identifier device; and
identifying a user corresponding to the unique identifier using the multi-purpose stylus.

12. The method of claim 1, further comprising:
incorporating a fingerprint sensor into the multi-purpose stylus; and
using the fingerprint sensor to authenticate a user holding the multi-purpose stylus to allow the user to operate the multi-purpose stylus.

13. The method of claim 2, further comprising:
incorporating a speaker into the multi-purpose stylus;
locating the speaker at one end of the multi-purpose stylus and the microphone at an opposite end of the multi-purpose stylus; and
using the multi-purpose stylus as a telephone such that user talks into the microphone and listens with the user's ear near the speaker.

14. The method of claim 1, further comprising:
incorporating a wireless transceiver into the multi-purpose stylus;
wirelessly communicating with an auxiliary device not in communication with the computing device; and
remotely controlling the auxiliary device with the multi-purpose stylus.

15. A computer-readable storage medium in communication with a multi-purpose stylus, the computer-readable medium having stored thereon computer-executable instructions for interacting with a computing device, comprising:
inputting data into the computing device by physically contacting a tip of the multi-purpose stylus with a surface of the computing device;
pausing a main task of the computing device that a user is working on;
speaking a voice command from the user into a microphone located on the multi-purpose stylus; and
applying the voice command such that the voice command is carried out by the computing device.

16. The computer-readable storage medium of claim 15, further comprising:
providing notifications to the user using a tactile feedback device incorporated into the multi-purpose stylus;
receiving a notification from the computing device; and
notifying the user of the notification from the computing device using the multi-purpose stylus.

17. A multi-purpose stylus, comprising:
a stylus body;
a tip at one end of the stylus body for contacting the surface of a computing device in order to input data into the computing device;
a microphone located in the stylus body to allow a user to issue voice commands to the computing device without the use of physically contacting the surface with the stylus tip;
a transceiver located in the stylus body for wireless communication with the computing device; and
an accelerometer located in the stylus body for interpreting gestures made by the user while holding the multi-purpose stylus and sending this information to the computing device using the transceiver.

18. The multi-purpose stylus of claim 17, further comprising a color sensor located in the stylus body that provides color coordinates for a specified object.

19. The multi-purpose stylus of claim 18, further comprising:
a laser pointer located at the stylus tip; and
a camera located in the stylus body oriented so that it can capture images of what the laser pointer is pointing at.

20. The multi-purpose stylus of claim 19, further comprising a docking cradle on the computing device for recharging the multi-purpose stylus such that as soon as the multi-purpose stylus is placed in the docking cradle its battery is being recharged.
